(19) United States
(12) Patent Application Publication
(10) Pub. No.: US 2012/0140987 A1
(43) Pub. Date: Jun. 7, 2012

(54) Methods and Systems for Discovering Styles Via Color and Pattern Co-Occurrence

(75) Inventors: Sudhir Kumar Singh, San Jose, CA (US); Nima Sarshar, Fremont, CA (US); Vwani Roychowdhury, Los Angeles, CA (US)

(73) Assignee: Haileo Inc.

(21) Appl. No.: 13/312,752

(22) Filed: Dec. 6, 2011

Related U.S. Application Data
(60) Provisional application No. 61/459,063, filed on Dec. 6, 2010.

(51) Int. Cl. G06K 9/00; G06K 9/34

(52) U.S. Cl. 382/103; 382/164

(57) ABSTRACT

Methods and systems for discovering styles via color and pattern co-occurrence are disclosed. According to one embodiment, a computer-implemented method comprises collecting a set of fashion images, selecting at least one subset within the set of fashion images, the subset comprising at least one image containing a fashion item, and computing a set of segments by segmenting the at least one image into at least one dress segment. Color and pattern representations of the set of segments are computed by using a color analysis method and a pattern analysis method respectively. A graph is created wherein each graph node corresponds to one of a color representation or a pattern representation computed for the set of segments. Weights of edges between nodes of the graph indicate a degree of how the corresponding colors or patterns complement each other in a fashion sense.

The present application claims benefit of and priority to U.S. Provisional Application Ser. No. 61/459,063 titled “METHODS AND SYSTEMS FOR DISCOVERING STYLES VIA COLOR AND PATTERN CO-OCCURENCE” filed Dec. 6, 2010 which is hereby incorporated by reference herein in its entirety.

### FIELD

The disclosure relates generally to computer systems and applications and, more particularly, to methods and systems for discovering styles via color and pattern co-occurrence.

### BACKGROUND

For a perfect fashionable look each part of an ensemble should blend well with the other parts. Not all combinations of “shirt-tie-suit” or “top-skirt” or “dress-bag” will result in a fashionable look. Further, stylish combinations change over time as new trends develop. Although some dress combos may be easier to come up with, in general it can be daunting to mix and match elegant colors and patterns and come up with perfectly fashionable combinations.

### SUMMARY

Methods and systems for discovering styles via color and pattern co-occurrence are disclosed. According to one embodiment, a computer-implemented method for building a style graph comprises collecting a set of fashion images, selecting at least one subset within the set of fashion images, the subset comprising at least one image containing a fashion item, and computing a set of segments by segmenting the at least one image into at least one dress segment selected from a group consisting of a dress, a bag, a shoe, a piece of jewelry, a shirt, a suit, a tie, a top, a skirt, and a fashion accessory. Color and pattern representations of the set of segments are computed by using a color analysis method and a pattern analysis method respectively and a graph is created wherein each graph node corresponds to one of a color representation or a pattern representation computed for the set of segments, and weights of edges between nodes of the graph indicate a degree of how the corresponding colors or patterns complement each other in a fashion sense.

The systems, methods, features and advantages of the invention will be or will become apparent to one with skill in the art upon examination of the following figures and detailed description. It is intended that all such additional methods, features and advantages be included within this description, be within the scope of the invention, and be protected by the accompanying claims. It is also intended that the invention is not limited to require the details of the example embodiments.

### BRIEF DESCRIPTION

The accompanying drawings, which are included as part of the present specification, illustrate the presently preferred embodiment and, together with the general description given above and the detailed description of the preferred embodiment given below, serve to explain and teach the principles of the present invention.

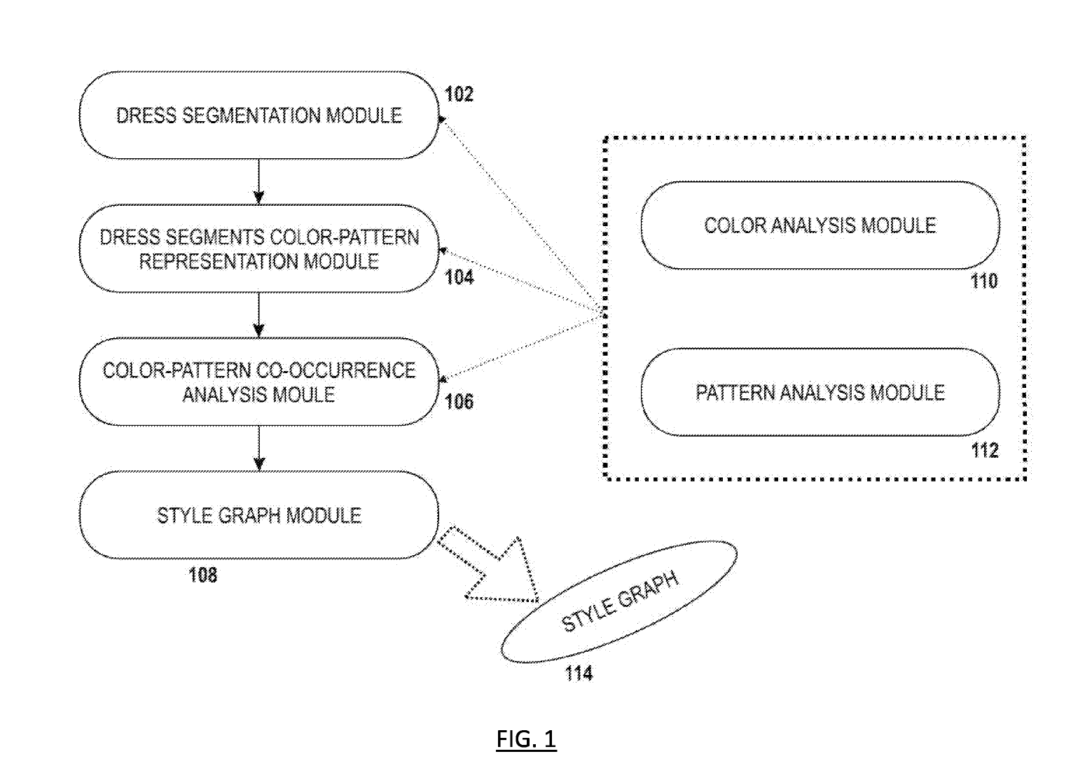

FIG. 1 illustrates an exemplary style discovery process based on color and pattern co-occurrence, according to one embodiment.

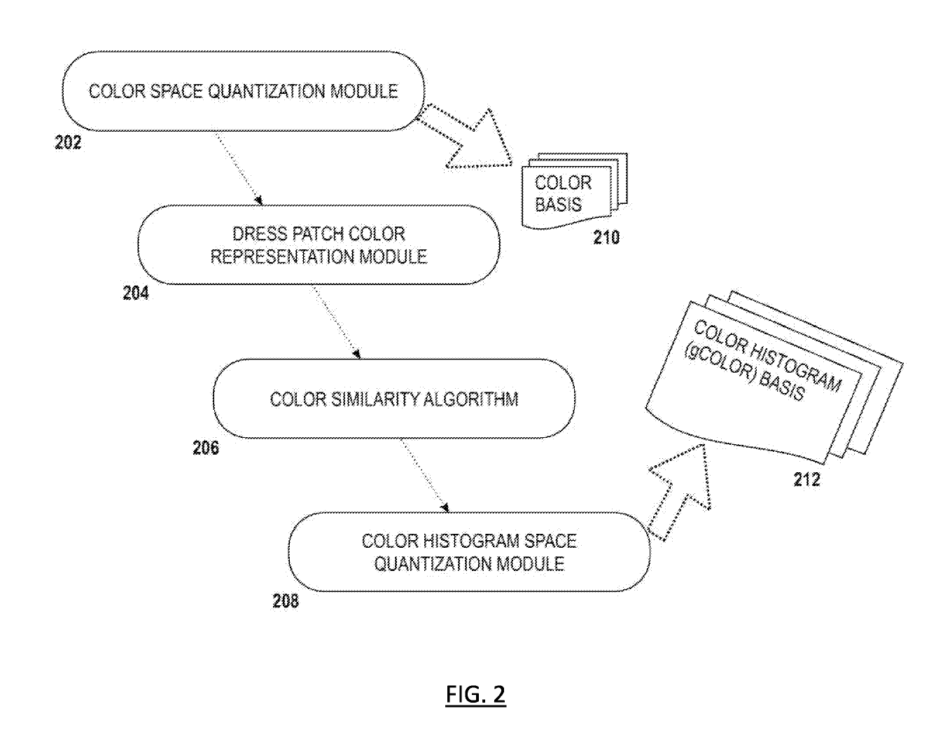

FIG. 2 illustrates an exemplary color analysis module for use with the present system, according to one embodiment.

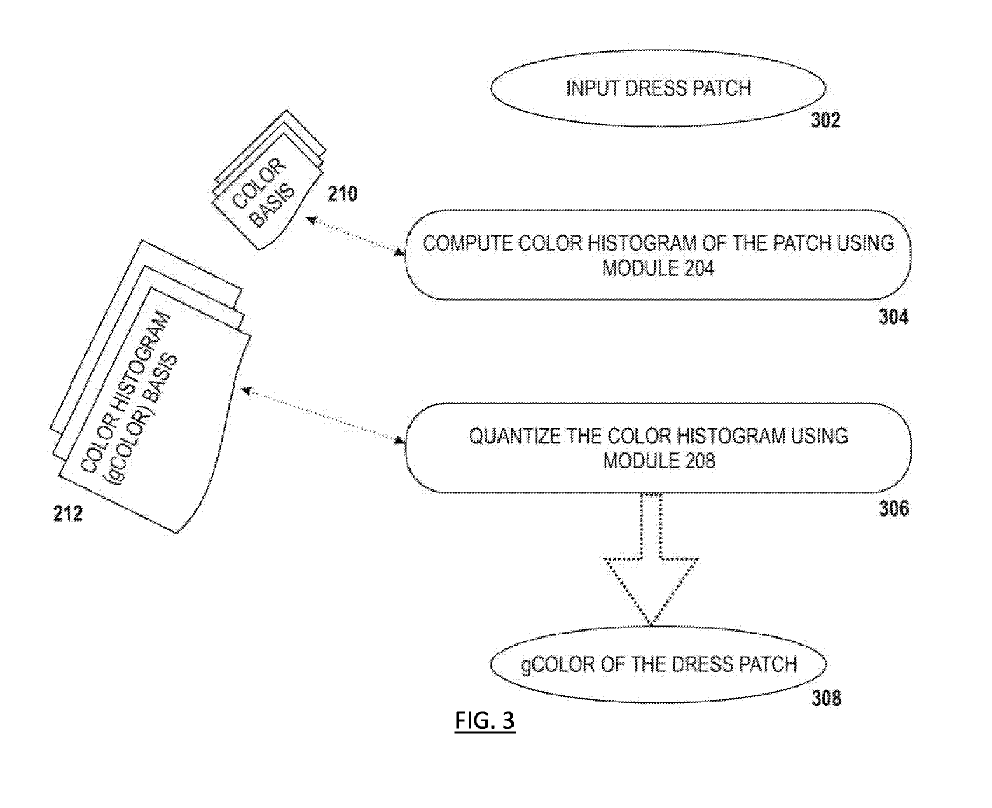

FIG. 3 illustrates an exemplary color representation computation process for use with the present system, according to one embodiment.

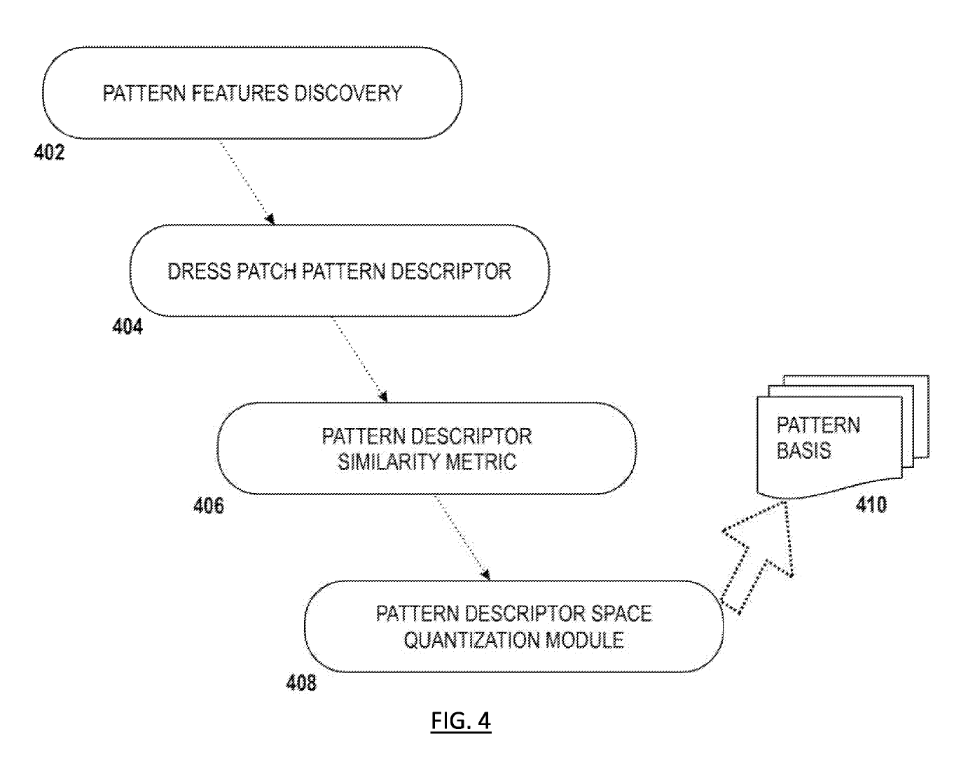

FIG. 4 illustrates an exemplary pattern analysis module for use with the present system, according to one embodiment.

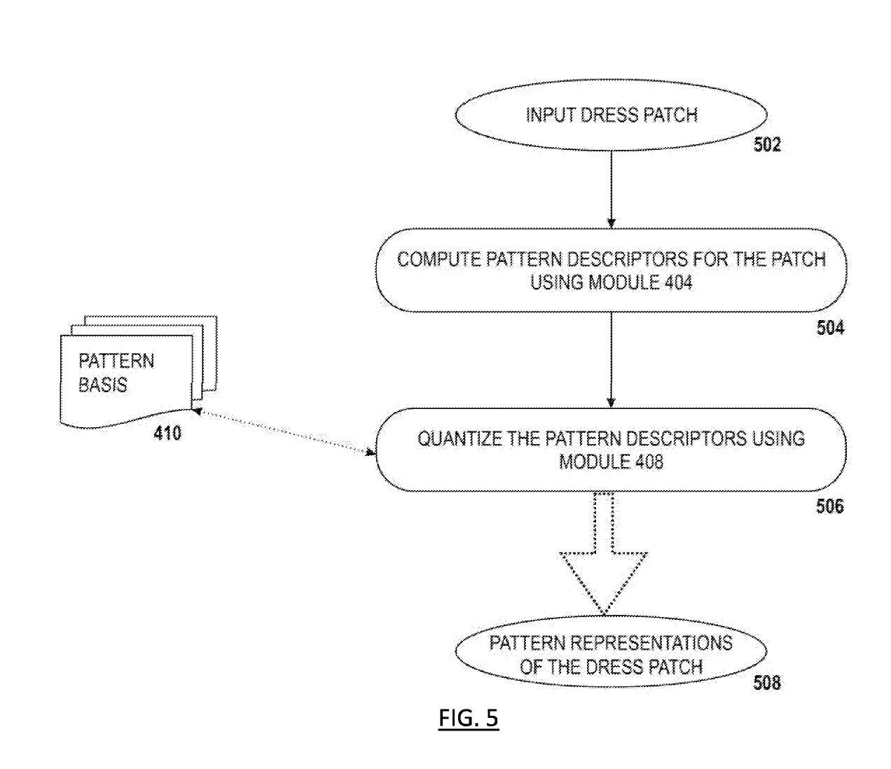

FIG. 5 illustrates an exemplary pattern representation computation process for use with the present system, according to one embodiment.

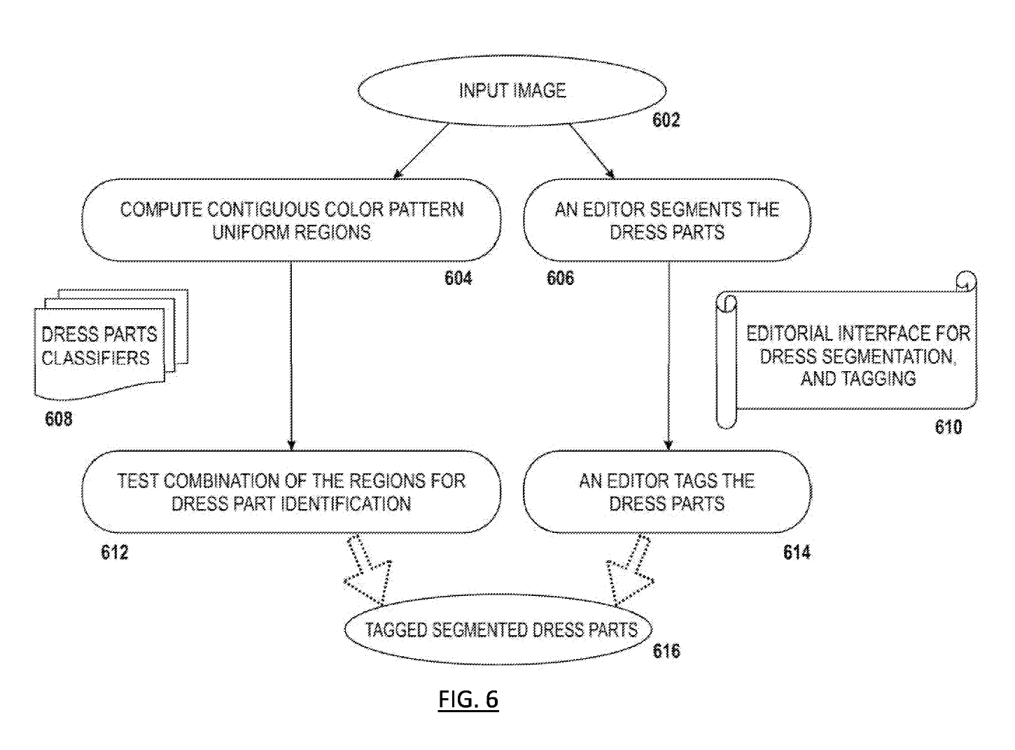

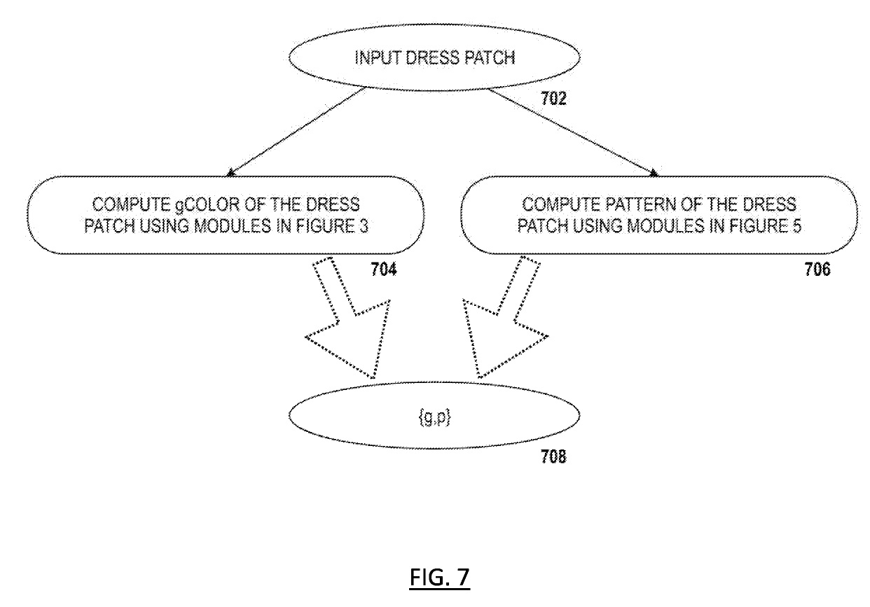

FIG. 6 illustrates an exemplary dress segmentation module for use with the present system, according to one embodiment.

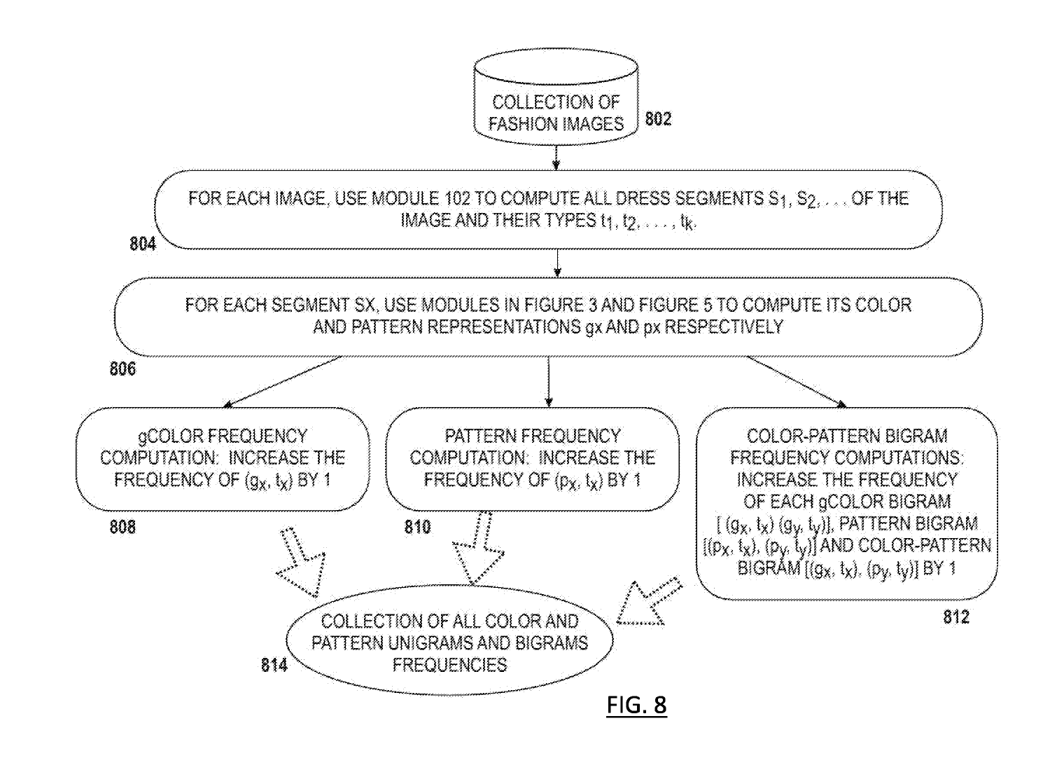

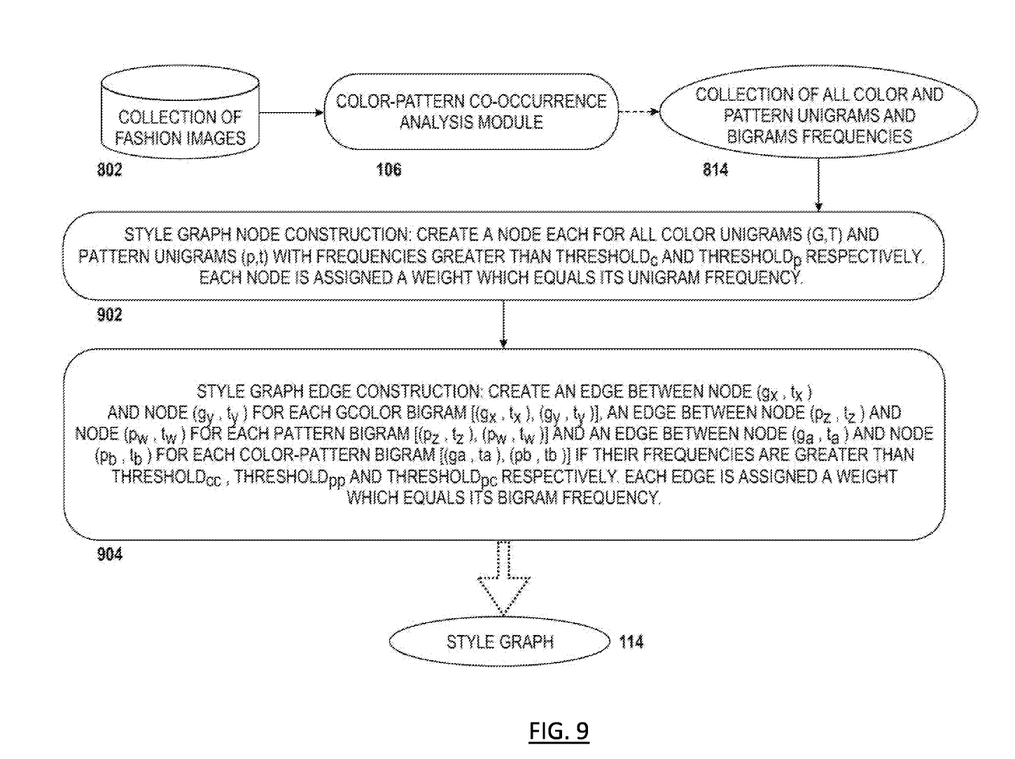

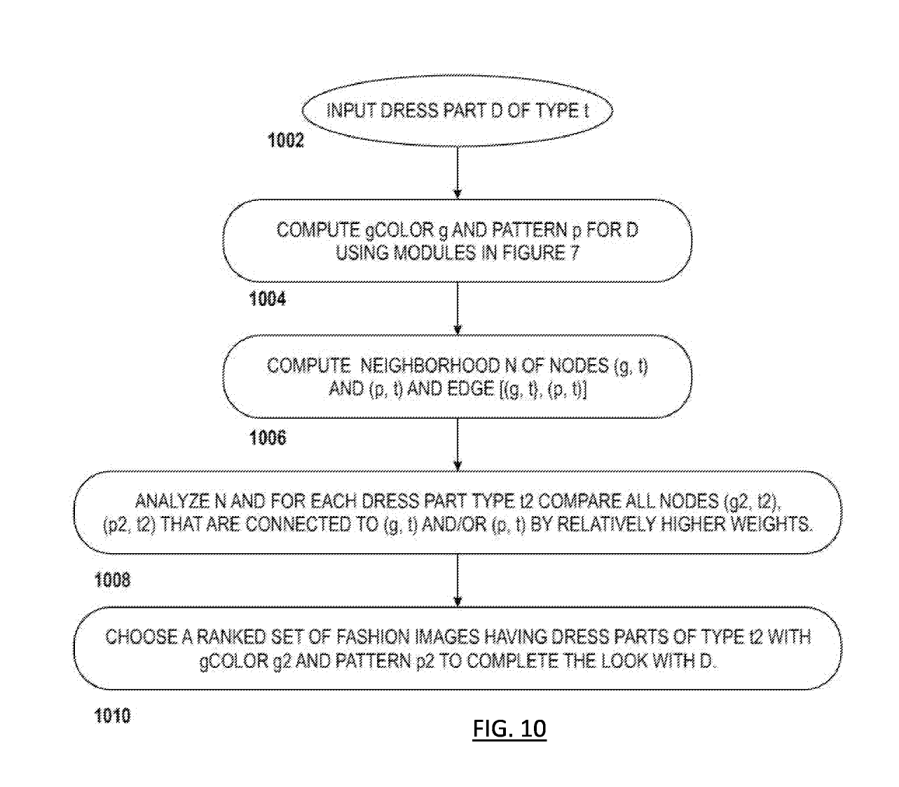

FIG. 7 illustrates an exemplary color and pattern computation flow for use with the present system, according to one embodiment.

FIG. 8 illustrates an exemplary color pattern co-occurrence analysis process for use with the present system, according to one embodiment.

FIG. 9 illustrates an exemplary style graph construction process for use with the present system, according to one embodiment.

FIG. 10 illustrates an exemplary recommendation process for use with the present system, according to one embodiment.

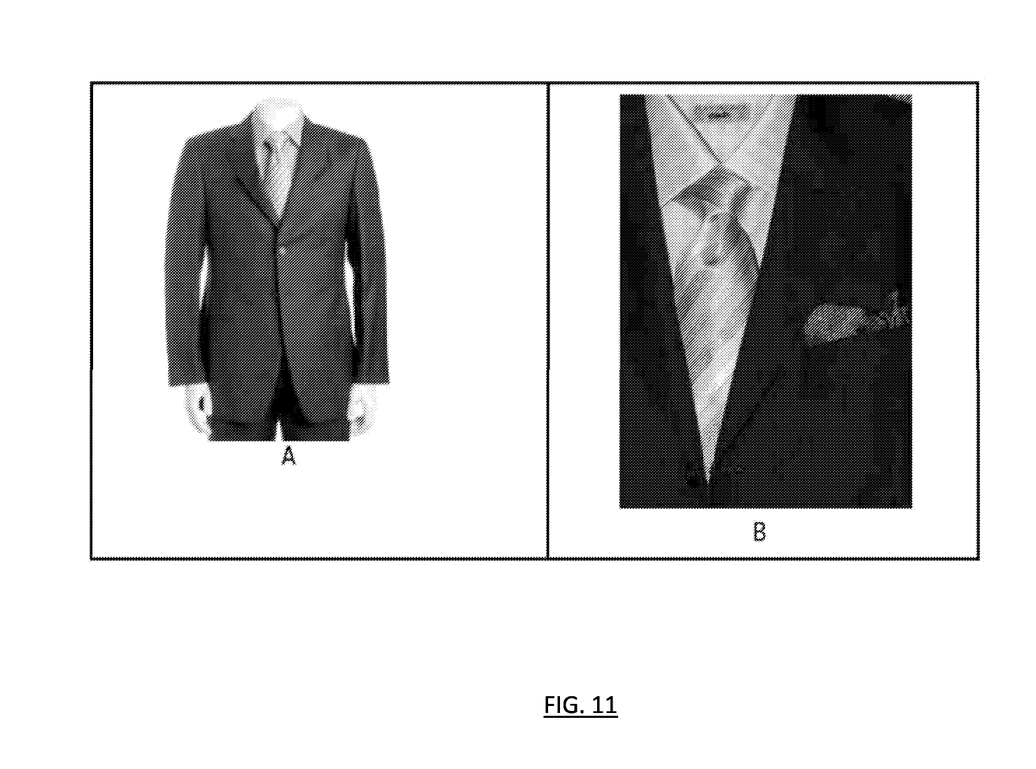

FIG. 11 illustrates an exemplary tie-shirt-suit combination.

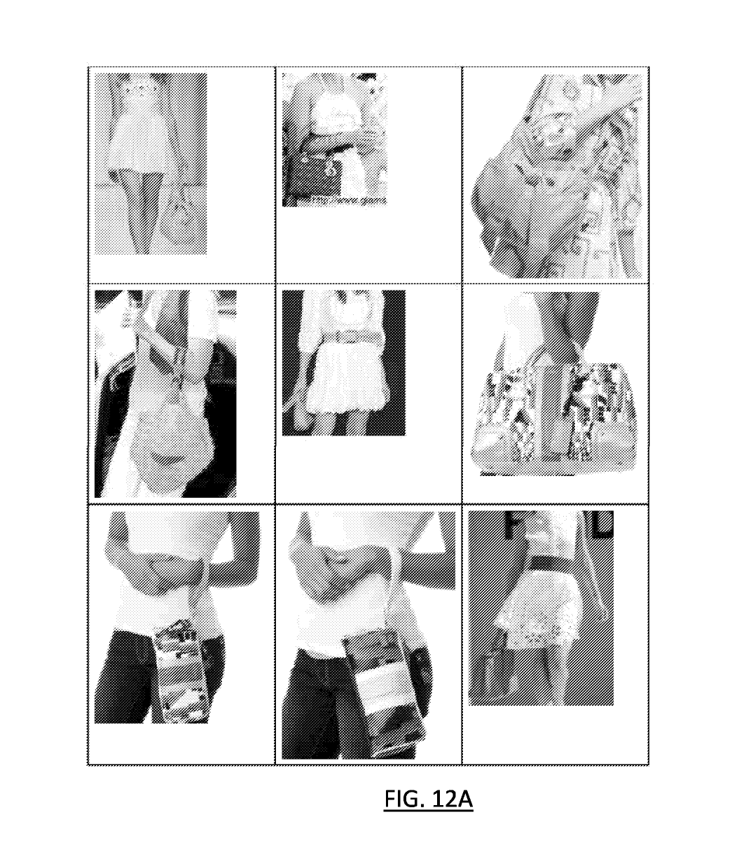

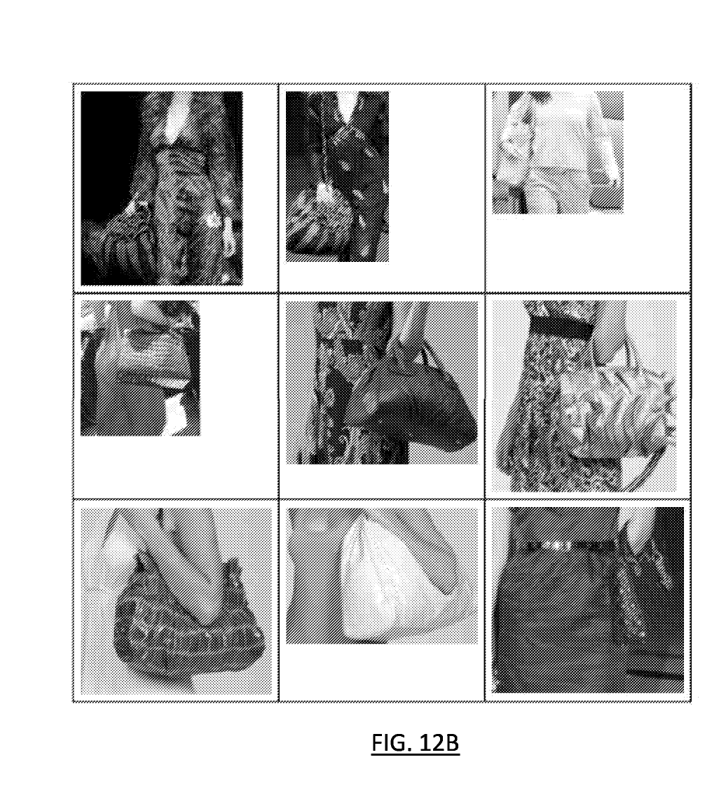

FIGS. 12A-B illustrate exemplary fashion combinations.

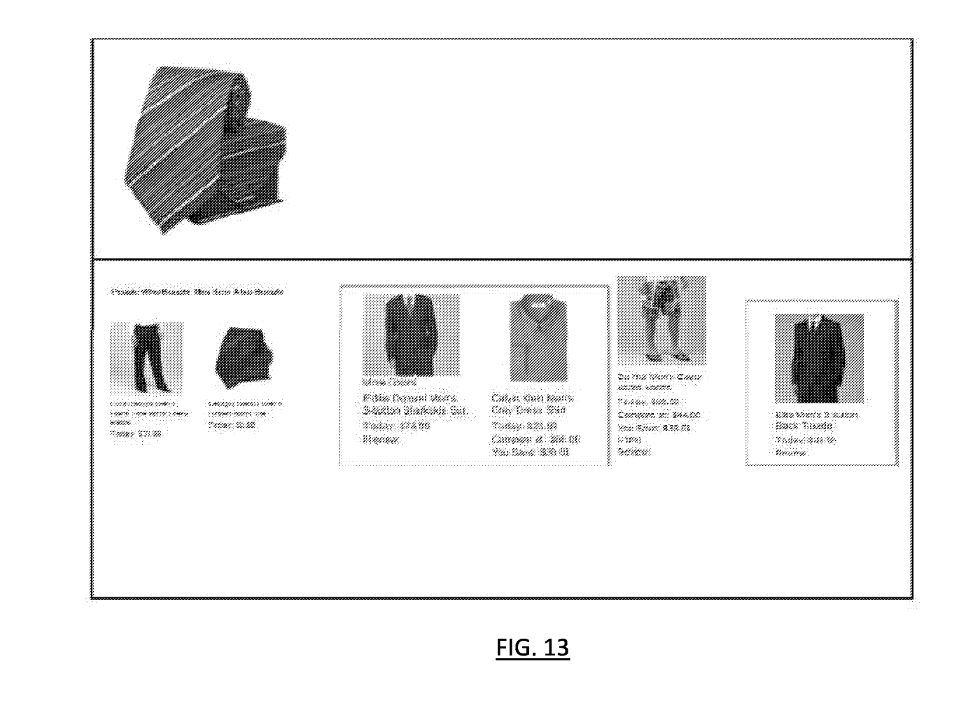

FIG. 13 illustrates exemplary use of purchase and viewership logs.

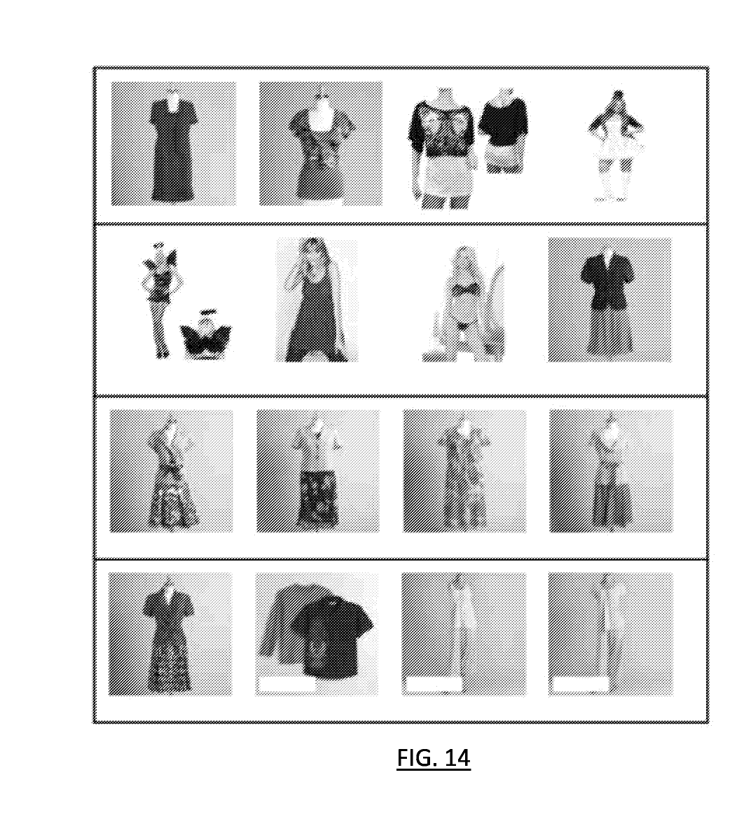

FIG. 14 illustrates exemplary co-occurrence, according to one embodiment.

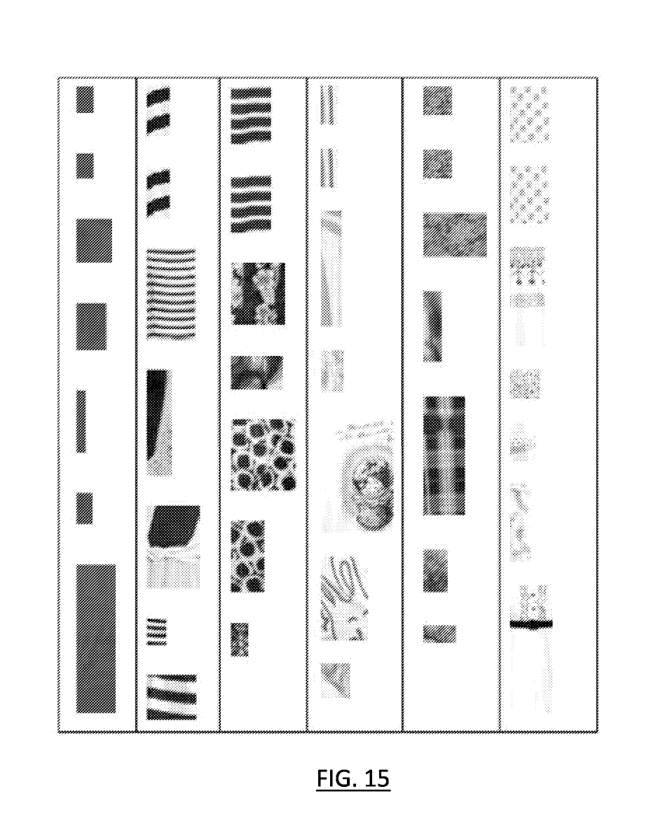

FIG. 15 illustrates exemplary ranking of images by an exemplary color similarity algorithm, according to one embodiment.

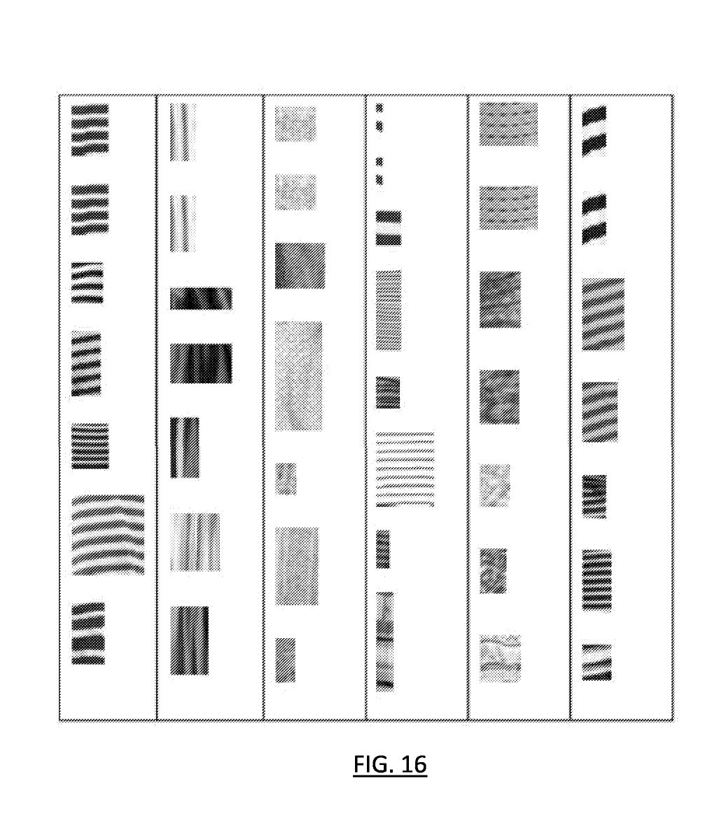

FIG. 16 illustrates exemplary ranking of images by an exemplary pattern similarity algorithm, according to one embodiment.

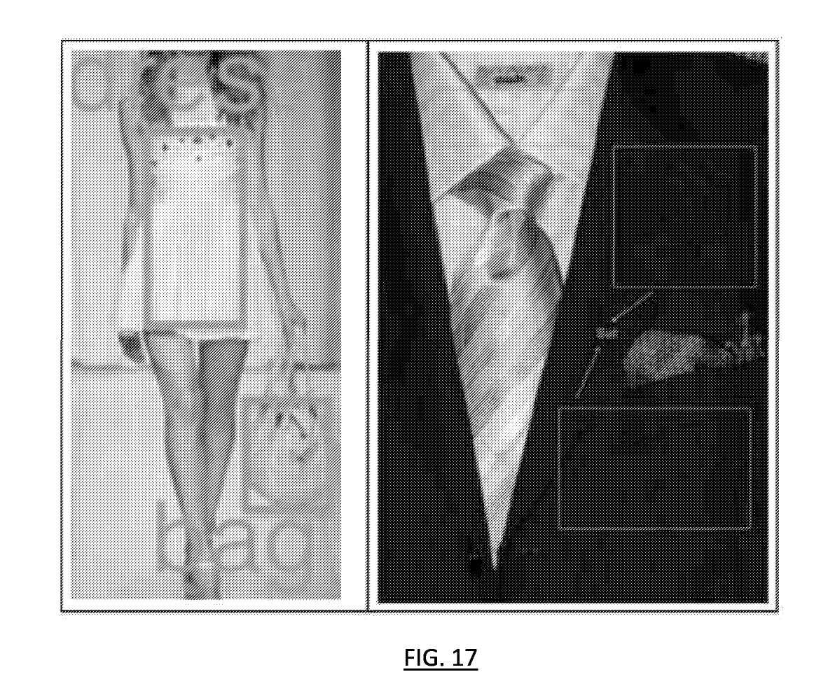

FIG. 17 depicts exemplary dress segmentation for use with the present system, according to one embodiment.

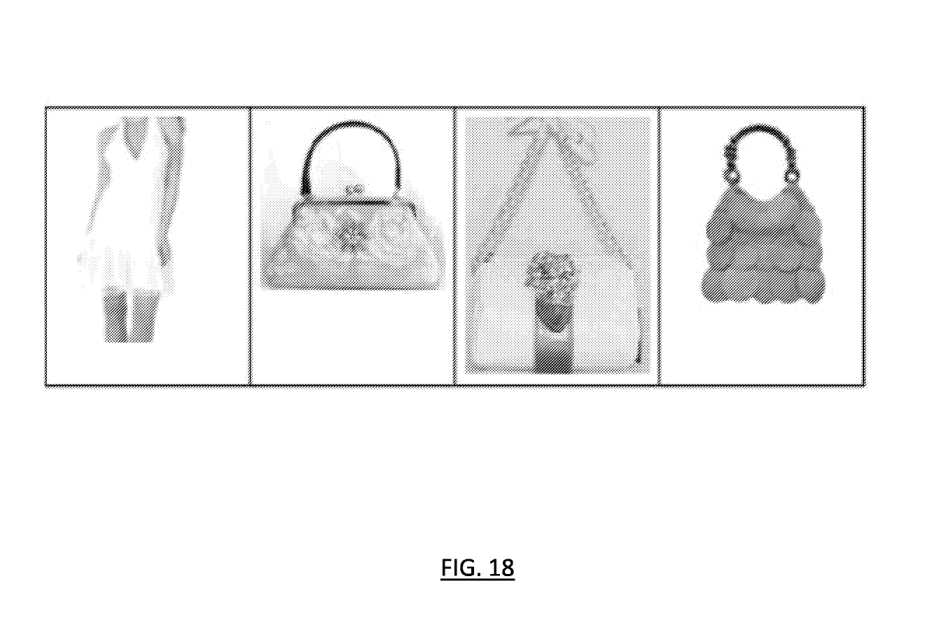

FIG. 18 illustrates exemplary bag recommendations, according to one embodiment of the present system.

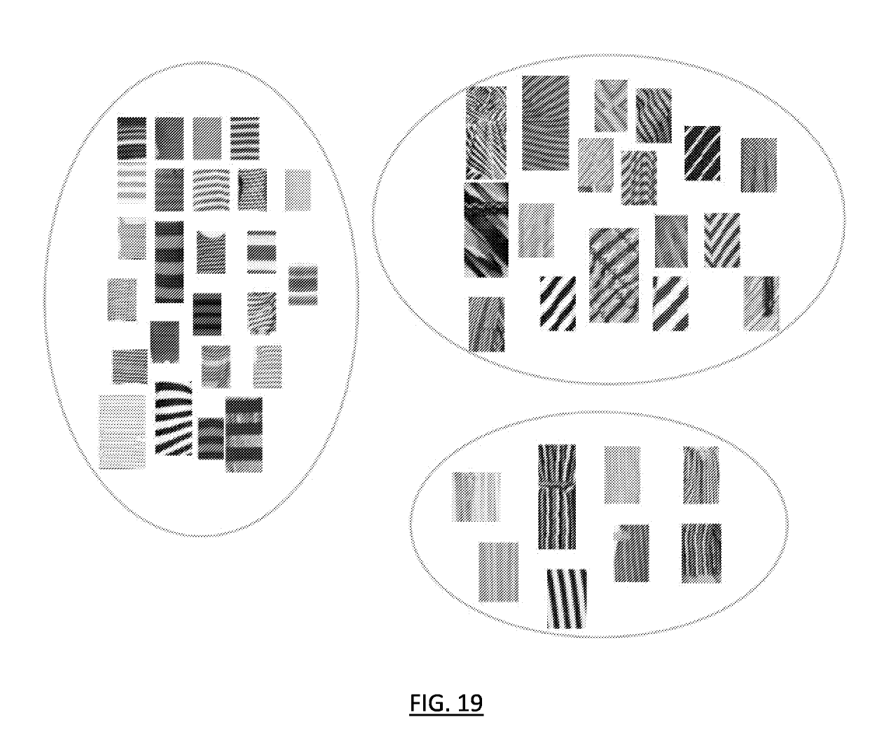

FIG. 19 illustrates an exemplary subset of an exemplary pattern basis for use with the present system, according to one embodiment.

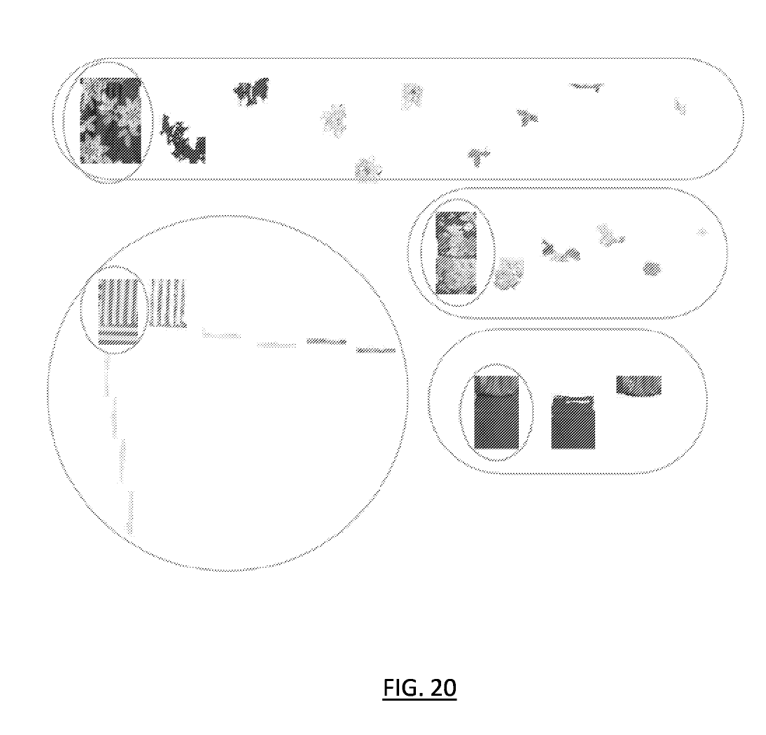

FIG. 20 illustrates exemplary outputs of exemplary color segmentation for use with the present system, according to one embodiment.

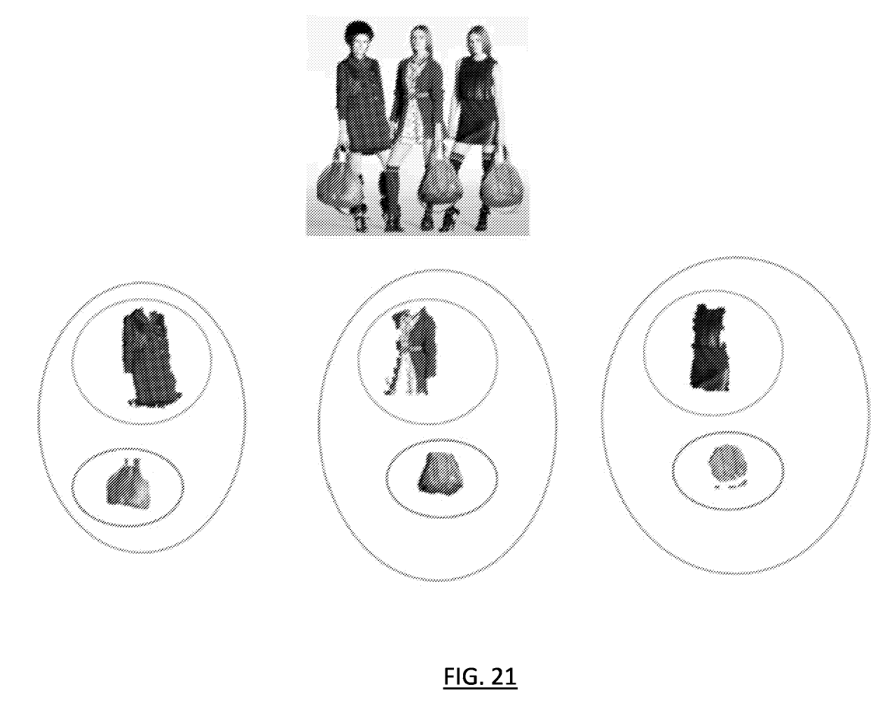

FIG. 21 illustrates an exemplary automatic dress segmentation for use with the present system, according to one embodiment.

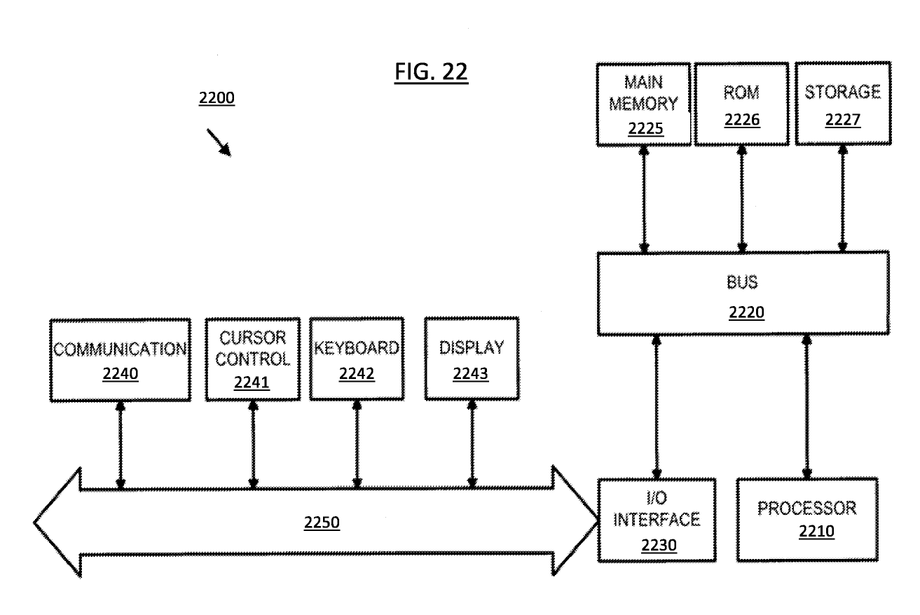

FIG. 22 illustrates an exemplary computer architecture for use with the present system, according to one embodiment.

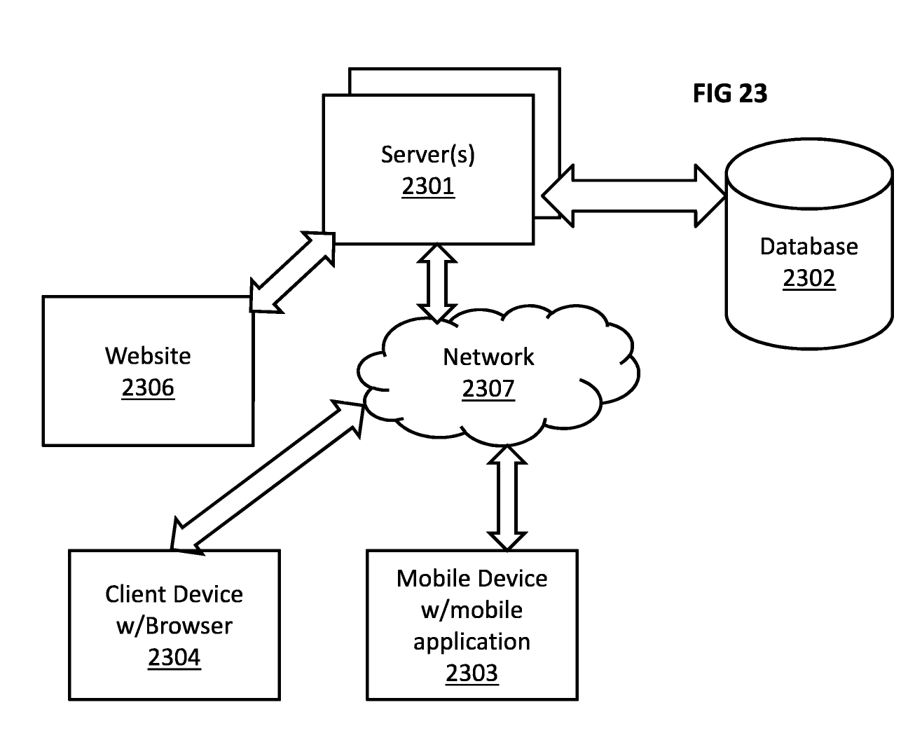

FIG. 23 illustrates an exemplary system level layout for use with the present system, according to one embodiment.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not necessarily describe every aspect of the teachings disclosed herein and do not limit the scope of the claims.

### DETAILED DESCRIPTION

The present system and method discover dress styles by analyzing the color, pattern and co-occurrence statistics in fashion images and videos available on the web and/or from dedicated sources such as fashion shows, purchase or viewership logs of fashion vendors. Styles are determined by asking the question “what goes with what” wherein “what” represents features such as colors and patterns. A style graph is built to capture what color patterns of first fashion items pair with what color patterns of other secondary fashion items. Once the style graph is built, it can be harnessed for a myriad of applications—from completing the look (e.g. given a shirt, selecting an appropriate tie) to discovering fashion trends hitting the blog-sphere.

Dress styles are more or less governed by colors, patterns and their combinations (what color/pattern goes with what color/pattern) and in the Internet era it is not hard to find representative examples of various styles (e.g. from dress/fashion images and videos available on the web, fashion shows, purchase logs of fashion vendors). FIG. 11 illustrates an exemplary tie-shirt-suit combination. FIGS. 12A-B illustrate exemplary fashion combinations. FIG. 14 illustrates exemplary co-occurrence, according to one embodiment wherein popularity of a solid top with a patterned skirt is apparent.

FIG. 1 illustrates an exemplary style discovery process based on color and pattern co-occurrence, according to one embodiment. A color analysis module 110 and pattern analysis module 112 enable the style discovery process achieved using dress segmentation module 102, dress segments color-pattern representation module 104, color-pattern co-occurrence analysis module 106 and style graph construction module 108. Given a fashion image or a video frame, dress segmentation module 102 detects various dress parts such as tie, shirt, suit, top, skirt, bag, and jewelry in the image. This module can either be fully automatic or an editorial help may also be taken. Mapping the above dress parts to appropriate color and pattern types is provided by a dress segments color-pattern representation module 104. Given a collection of fashion images and videos, color-pattern co-occurrence analysis module 106 analyzes the images and video frames to gather statistics on which colors and patterns appear together more often as various dress parts as compared to others to capture bias hidden in their co-occurrence. The statistics are then used by the style graph construction module 108 to build a style graph that represents the “what goes with what” relationships among various colors and patterns with respect to various possible dress parts. A more detailed description of each of the modules as part of a preferred embodiment of the present disclosure follows. It will be appreciated by one of ordinary skill in the art that, while the present disclosure includes implementation details related to various modules, the present system and method can be implemented as a combination of fewer or more modules than is described herein without departing from the scope of the present disclosure.

For a computing device, interpreting the color mix in a given dress image or video frame is not as easy as it may seem at first glance. Traditional solid color such as red, green, yellow, and blue are not the only ones to be recognized and interpreted. Colors have a myriad of variations (e.g. light blue, sky blue, deep sea blue, navy blue). Further, there are a myriad of complex color mixtures possible by combining these colors in various proportions—sometimes visible as patterns and sometimes not visible as patterns. Image pixels are represented in a given format such as RGB, or HSV. The present disclosure utilizes HSV as a preferred color space in describing a preferred embodiment, however other formats are applicable within the scope of the present system. Each pixel is represented as a vector in a 3-dimensional Euclidean space and each of the 3-coordinates values are in the interval [0,1] representing Hue, Saturation, and Value respectively. In these representations, there are infinite numbers of color possibilities as the pixel colors may take any value from 0 to 1 along any of the H, S, or V dimensions.

FIG. 2 illustrates an exemplary color analysis module for use with the present system, according to one embodiment. Color space quantization module 202 represents images as mixes of various colors by mapping the color possibilities to a finite K-dimensional space (e.g. K=100). Given a database of (dress) images, each pixel in the image is represented as HSV and serves as a training example. Then K 3-D vectors (color basis 210 in FIG. 2) can be learned using a K-means or K-medoids clustering algorithm. The K vectors define the color space and comprise the color basis 210 and each of the vectors is referred to as a color. Note that the K vectors may not correspond to one of the traditional colors-red, blue, green, yellow, cyan, orange.

A given HSV vector can be mapped to one of the K colors by computing the distance (e.g. Euclidean distance) between the given 3-D vector to all the K vectors and choosing the closest one. The dress patch color representation module 204 uses this mapping logic to compute a color representation for any given image. Given an image or a patch in the image or a set of pixels in the image, each pixel is represented in HSV and is mapped to one of the K colors. A histogram of the K colors is computed by collecting and counting all the pixels that are mapped to their respective colors. The resulting color histogram is a K-dimensional vector where an i^{th} coordinate is the fraction of pixels mapped to the i^{th} color. The color histogram serves as a color description of the given image.

Given two images, the similarity of the two by color is computed by using the similarity of the corresponding color histograms according to a distance metric that is computed by the color similarity algorithm 206. In one embodiment, a naive distance metric that could be used is the Euclidean distance (i.e. L2 metric) between the histogram vectors (or their L2 normalized versions). However, the distance metric does not provide a robust perceptive measure of similarity.

According to one embodiment, an inventive distance metric as part of the present disclosure is defined as follows. First, the pair wise Euclidean distance between each pair of the K colors is computed (recall that each of these K colors is actually a 3-D HSV vector). For pair (i,j) the pair wise Euclidean distance is denoted by d_{i,j}. For each of the K colors, all colors can be ranked according to this distance, with the minimum distance (i.e. most similar) first. The top L of the ranked K colors are selected for each color i=1, 2, . . . , K and are called the top neighbors of the color i. A bipartite graph with K left nodes and K right nodes is created. The i^{th} left node is associated with a weight equal to the value of the i^{th} coordinate in the first color histogram. Similarly, the j^{th} right node is assigned a weight equal to the value of the j^{th} coordinate in the second color histogram. Each left node i is connected to the L nodes corresponding its top neighbors and each such edge (i,j) is assigned a weight value equivalent to d_{i,j}.

Each color is similar to each of its top neighbors up to a penalty and the present system distributes the weight of the color in first histogram (i.e. a left node) to its top neighbors in the second histogram (i.e. corresponding L right nodes) and each such mapping along edge (i,j) is assigned a penalty value equivalent to d_{i,j}. If some part of the color is left unmatched to its top neighbors, it is given a penalty of dₘₐₓ (which is a value greater than all pair wise distances d_{i,j}, for example dₘₐₓ=2 in one preferred embodiment). Further, any node i on left or right can not be matched to its neighbors in a way so that sum of the matched portions from all the neighbors exceed the weight of the node i. The problem is to distribute the left node weights to their top neighbors so as to minimize the sum of all these penalties. The problem can be formulated as a linear program whose solution gives the minimum penalty matching. Similarly, minimum penalty matching is also computed by interchanging the roles of the first and the second color histograms. The average of these two values defines the distance between the two color histograms and therefore between the corresponding two images. Linear programming problem has polynomial time algorithms, the best being O(n^{2.38}), where n is the input size. This may still not always be feasible if one has to compute the distances for a huge collection of images. So, an algorithm to find the approximate minimum penalty matching may alternatively be used, first to compute a smaller number of most similar images and then to refine them by the original LP based algorithm. FIG. 15 illustrates exemplary ranking of images by the exemplary color similarity algorithm 206, according to one embodiment.

The space of color histograms (i.e. color-mixes) is quantized by the color histogram space quantization module 208 into M bins using similar techniques as in the color space quantization module 202 but using the distance metric as computed by the color similarity algorithm 206. These M bins comprise the color histogram basis 212. Given an image (or a part of the image) its color histogram is mapped to the closest of these M bins (the corresponding K-dimensional vectors) according to the color similarity algorithm 206. Each of these M bins is referred to as a gColor (for global color/overall color of the image patch). A pair of two gColors is called a gColor-bigram or a color bigram.

FIG. 3 illustrates an exemplary color representation computation process for use with the present system, according to one embodiment. For a given input dress patch 302, a step 304 uses the color basis 210 and module 204 to compute the color histogram for the dress patch. This color histogram is then quantized using module 208 and color basis 212 to obtain the gColor 308 of the given dress patch.

FIG. 4 illustrates an exemplary pattern analysis module for use with the present system, according to one embodiment. As in the case of color, understanding various patterns in a dress such as multitude of stripes, checkered, floral, polka dots, animal prints, geometrics is challenging. In a preferred embodiment, a gray scale representation of the given image (or the given image part) is obtained. A histogram of oriented gradients (HOG) vector is then calculated. HOG vectors are R-dimensional Euclidean vectors where R represents the resolution of the orientation. The distance between two HOG vectors is the Euclidean distance (i.e. L2 distance). Given an image, to obtain the most similar images by patterns from a database of images, the distances between the corresponding HOG vectors are computed and the images are ranked according to this distance, minimum first. The list of these images is further refined/pruned as follows.

Color histograms for each image are computed as explained previously in color analysis module 110. It is noted that the color histogram can also be understood as a probability distribution. The entropy for each of the color histograms (i.e. the probability distributions) is then computed. For each image, the entropy of its color histogram is referred to herein as its color entropy. The images whose color entropies are not within a threshold of the color entropy of the input image are either pruned or thrown lower in the pattern similarity ranking. FIG. 16 illustrates exemplary ranking of images by this exemplary pattern similarity algorithm, according to one embodiment.

As in the case of the space of color-mixes, the space of patterns includes infinite possibilities. The space of patters is quantized into P bins using techniques similar to that in the case of color-mixes. Given an image (or a part of the image) its HOG vector and color entropy are computed and mapped to the closest of these P bins (the corresponding R-dimensional HOG vectors) with appropriate penalty if color entropies are not consistent. Each of these P bins is referred to as a pattern. A pair of two patterns is called a pattern-bigram. It is noted that oriented gradients are features discovered by pattern features discovery module 402. The R-dimensional Euclidean vector is the corresponding descriptor of dress patch pattern descriptor module 404. The L2 distance modulated by the color entropy is the pattern descriptor similarity metric 406, and pattern descriptor space quantization module 408 quantizes those descriptors to P bins to obtain the pattern basis 410. This particular pattern feature serves well to identify various types of horizontal, vertical, and oblique stripes, wrinkles and folds. FIG. 19 illustrates an exemplary subset of an exemplary pattern basis for use with the present system, according to one embodiment, wherein each dress patch cluster corresponds to an element of the discovered pattern basis 410.

According to one embodiment, the pattern feature discovery module 402 can learn from a large collection of fashion images in an unsupervised manner about what characteristic of dress color patches actually describe a pattern. In one embodiment, given an image patch it is segmented into various parts that are uniform in color (for example using color similarity algorithm 206). FIG. 20 illustrates exemplary outputs of exemplary color segmentation for use with the present system, according to one embodiment. The distribution of sizes of the segments, their relative geometry, as well as their shapes may together serve well as pattern features. Module 402 examines a large collection of fashion images by obtaining their color uniform segments and analyzing their size distribution, relative geometry, and shapes and picks features that allow meaningful clustering with respect to a pattern descriptor 404 and a pattern descriptor similarity metric 406. In one embodiment, the shapes of the segments can be used as a potential pattern feature and a shape descriptor that represents the polar distribution of points in the shape can be used as a potential pattern descriptor.

Clustering based on this feature and the corresponding descriptor gives rise to various pattern rich clusters like polka dots (indicated by circles), floral (indicated by flower shapes), and stripes (indicated by thick lines). Since this clustering is meaningful in terms of dress patterns, shapes of uniform color segments can indeed be used as a pattern feature and polar distribution of points of the a shape can indeed be used as a pattern descriptor.

Thus, modules of FIG. 4 can be used to compute pattern representation of any given dress patch. FIG. 5 illustrates an exemplary pattern representation computation process for use with the present system, according to one embodiment.

FIG. 6 illustrates an exemplary dress segmentation module for use with the present system, according to one embodiment. The task of the dress segmentation module 102 is to detect various dress parts such as tie, shirt, suit, top, skirt, bag, and jewelry located on an input fashion image or a video frame that may consist of various dress parts. The dress segmentation module 102 may work fully automatically or semi-automatically with the help of an editor.

The semi-automatic technique consists of a web, desktop or mobile interface 610 where an image is provided to a human user and he/she segments the various parts and tags them (e.g. tie, shirt, suit, top, skirt, bag) with a predefined set of dress part types. The automatic technique utilizes the color and pattern understanding as described previously in this disclosure in modules 110 and 112 to compute the contiguous parts 604 in the image as per color or pattern similarity and to segment the image into large contiguous parts. The segments are then combined in step 612 and tested using dress part classifiers 608 if they can pass as a dress part or not. Further, a human detection as well as a face detection algorithm may also be used to facilitate the dress segmentation process. Exemplary outputs of exemplary dress segmentation modules are shown in FIG. 17 and FIG. 21, according to one embodiment.

FIG. 7 illustrates an exemplary color and pattern computation flow for use with the present system, according to one embodiment wherein mapping of dress parts obtained from dress segmentation module to appropriate gColor and pattern is obtained. For a given patch 702 for a dress part, step 704 computes its gColor using the algorithm described in FIG. 3, and step 706 computes its pattern using the algorithm described in FIG. 5.

FIG. 8 illustrates an exemplary color pattern co-occurrence analysis process for use with the present system, according to one embodiment. A collection of fashion images 802 is analyzed. For each dress part in each image, the corresponding gColor as well as the corresponding pattern is computed. The computed gColors are denoted as m₁, m₂, . . . , m_{T} and the computed patterns are denoted as p₁, p₂, . . . , p_{T} for the T dress parts of the given image respectively. Each gColor-bigram (mᵢ,mⱼ) is given one count for each image that it appears in and similarly for the pattern-bigram (pₖ,pₗ). At the end each such pair has a frequency which is a measure of how well a gColor or a pattern goes with another one (larger the better).

FIG. 9 illustrates an exemplary style graph construction process for use with the present system, according to one embodiment. The relationships among various gColors and patterns can be represented as a graph where nodes are gColors and patterns. There are edges between two nodes if they co-occur at least a certain number of times. Each such edge is associated with a weight representing the co-occurrence frequency of the corresponding two nodes and measures the strength of their relationship. The resulting graph is referred to as a style graph. The co-occurrence is computed in a slightly different manner if the database being used is a purchase log of a vendor. The dress parts correspond to the various types of items (e.g. shirt, tie, suit, top) and the two parts are said to co-occur if people who bought the first item also bought the second one or vice-versa. In one embodiment, a module is not needed to detect different dress parts in a given image and the given image itself is a part and it comes with the corresponding tag. FIG. 13 illustrates exemplary use of purchase and viewership logs for co-occurrence computation according to one embodiment.

A variety of recommendation systems can be built on top of the style graph and therefore can harness the co-occurrence statistics of various colors and patterns. Given a database of dress images, popular styles can be discovered by choosing the dress part combinations that have high strength in the style graph corresponding to the database. This can be further used to discover a particular celebrity look by considering the dress images only for the given celebrity. Also, by using the dress images from recent fashion shows and building the corresponding style graph, the trending styles can be essentially discovered by selecting the dress part combinations that have high strength in the style graph.

FIG. 10 illustrates an exemplary recommendation process for use with the present system, according to one embodiment, wherein the style graph is used to develop a “complete the look” recommendation system. Given any part of a dress, a corresponding gColor or pattern can be computed and a diverse set of styles can be suggested by reviewing the neighbors of the gColor and/or pattern in the style graph and by suggesting other parts of the dress having gColor or pattern similar to the neighbors. Such styles can be further ranked by using the weight of the edges to the neighbors. FIG. 18 illustrates exemplary bag recommendations, according to one embodiment. Here, the input is a dress and a bag is suggested based on co-occurrence of colors and patterns via the style graph built on top of a database of fashion images.

FIG. 22 illustrates an exemplary computer architecture for use with the present system, according to one embodiment. One embodiment of architecture 2200 comprises a system bus 2220 for communicating information, and a processor 2210 coupled to bus 2220 for processing information. Architecture 2200 further comprises a random access memory (RAM) or other dynamic storage device 2225 (referred to herein as main memory), coupled to bus 2220 for storing information and instructions to be executed by processor 2210. Main memory 2225 also may be used for storing temporary variables or other intermediate information during execution of instructions by processor 2210. Architecture 2200 also may include a read only memory (ROM) and/or other static storage device 2226 coupled to bus 2220 for storing static information and instructions used by processor 2210.

A data storage device 2227 such as a magnetic disk or optical disc and its corresponding drive may also be coupled to computer system 2200 for storing information and instructions. Architecture 2200 can also be coupled to a second I/O bus 2250 via an I/O interface 2230. A plurality of I/O devices may be coupled to I/O bus 2250, including a display device 2243, an input device (e.g., an alphanumeric input device 2242 and/or a cursor control device 2241).

The communication device 2240 allows for access to other computers (servers or clients) via a network. The communication device 2240 may comprise one or more modems, network interface cards, wireless network interfaces or other well known interface devices, such as those used for coupling to Ethernet, token ring, or other types of networks.

FIG. 23 illustrates an exemplary system level layout for use with the present system, according to one embodiment. A server (or plurality of servers) having software according to the present disclosure 2301 is in communication with a network 2307 and a database 2302. It is understood that the database 2302 may be a separate entity from the server 2301 or plurality of servers, or the database 2302 may reside on the server 2301 or plurality of servers without departing from the scope of the present disclosure. Included in the server 2301 or plurality of servers is a web server, for hosting a website 2306 accessible by any client computing device having a browser 2304 in communication over the network 2307. A mobile device having a mobile application 2303 for use with the present system is also in communication with the network 2307 in order to provide necessary information to the server 2301.

In the description above, for purposes of explanation only, specific nomenclature is set forth to provide a thorough understanding of the present disclosure. However, it will be apparent to one skilled in the art that these specific details are not required to practice the teachings of the present disclosure.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms presented herein are not inherently related to any particular computer or other apparatus. Various general purpose systems, computer servers, or personal computers may be used with programs in accordance with the teachings herein, or it may prove convenient to construct a more specialized apparatus to perform the required method steps. The required structure for a variety of these systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter.

It is also expressly noted that the dimensions and the shapes of the components shown in the figures are designed to help to understand how the present teachings are practiced, but not intended to limit the dimensions and the shapes shown in the examples.

Systems and methods for discovering styles via color and pattern co-occurrence have been disclosed. It is understood that the embodiments described herein are for the purpose of elucidation and should not be considered limiting the subject matter of the disclosure. Various modifications, uses, substitutions, combinations, improvements, methods of productions without departing from the scope or spirit of the present invention would be evident to a person skilled in the art.

What is claimed is:

1. A computer-implemented method for building a style graph comprising:
collecting a set of fashion images;
selecting at least one subset within the set of fashion images, the subset comprising at least one image containing a fashion item;
computing a set of segments by segmenting the at least one image into at least one dress segment selected from a group consisting of a dress, a bag, a shoe, a piece of jewelry, a shirt, a suit, a tie, a top, a skirt, and a fashion accessory;
computing color and pattern representations of the set of segments by using a color analysis method and a pattern analysis method respectively; and
creating a graph wherein each graph node corresponds to one of a color representation or a pattern representation computed for the set of segments, and wherein weights of edges between nodes of the graph indicate a degree of how the corresponding colors or patterns complement each other in a fashion sense.

2. The computer-implemented method of claim 1 wherein, the set of fashion images is received from a group of sources consisting of the World Wide Web, fashion shows, movie archives, award ceremonies, fashion magazines, purchase or viewership log of fashion vendors, and user uploaded fashion images via a mobile application.

3. The computer-implemented method of claim 1 further comprising:
computing contiguous regions uniform in color and pattern description;
identifying combinations of the uniform regions that make up a dress part using a set of classifiers for dress parts; and
tagging the identified combinations of the uniform regions with a class of corresponding dress part.

4. The computer-implemented method of claim 1, further providing an editorial interface for segmenting and tagging dress parts, wherein an editor segments a given image into a set of segments and tags the segments with classes of corresponding dress parts.

5. The computer-implemented method of claim 3, wherein the identifying employs a face detection algorithm.

6. The computer-implemented method of claim 3, wherein the identifying employs a human detection algorithm.

7. The computer-implemented method of claim 1, further comprising:
selecting a subset of images from a collection of fashion images, the subset containing at least one image;
segmenting at least one image in the selected subset of images to create a set of dress segments;
representing at least two segments s1 and s2 in the set of dress segments, s1 and s2 being of types t1 and t2 respectively, as corresponding colors g1 and g2, and patterns p1 and p2 respectively;
mapping the at least two segments s1 and s2 to nodes Nc1, Nc2, Np1, Np2 in the graph corresponding to (g1,t1), (g2,t2), (p1,t1), and (p2,t2) respectively; and
updating the weight of all the edges between nodes Nc1, Nc2, Np1, Np2 when s1 and s2 satisfy a co-occurrence criteria.

8. The computer-implemented method of claim 7, wherein the co-occurrence criteria is satisfied if the segments s1 and s2 come from the same image.

9. The computer-implemented method of claim 7, wherein the co-occurrence criteria is satisfied if the segments s1 and s2 each come from at least one image of at least one item from a purchase or viewership log of a fashion vendor and if there is at least a predetermined number of users of the said fashion vendor who bought or viewed the said at least one item containing s1 as well as the said at least one item containing s2.

10. The computer-implemented method of claim 1, further comprising:
selecting a color space to represent pixel color intensities;
quantizing the color space into K bins by collecting examples of color values in the color space from a collection of images and by using K-means or K-medoids clustering algorithm to obtain K color bins, wherein any pixel value in the color space is mapped to the closest vector in this basis; and
representing a given image or part of an image or a set of pixels in an image as a color histogram by collecting and counting all the pixels that mapped to their respective colors in the color basis consisting of the said K colors where ith coordinate represents the fraction of pixels mapped to the ith color.

11. The computer-implemented method of claim 10, further comprising:
computing a distance between two color histograms f1 and f2, the computing comprising mapping each coordinate of f1 to L>1 coordinates of f2 and vice versa;
computing a penalty for each such coordinate mapping;
wherein the penalty is computed such that the closer coordinate mappings incur smaller penalties, and
wherein additional penalties are incurred if a part of a coordinate is left unmatched, and
wherein a total penalty is computed as the sum of matched proportions multiplied by their respective penalties plus the penalties for the unmatched portions;
wherein the best matching is found to minimize the total penalty exactly or approximately; and
wherein the penalty for the best match is declared as the value of the color histogram similarity measure;
quantizing the color histogram space into M bins using K-medoids; and
given a dress patch, computing a color representation for the patch by computing its color histogram and mapping it to one of the M bins.

12. The computer-implemented method of claim 1 further comprising:
discovering characteristics that enable pattern understanding by examining a collection of images, obtaining their uniform color segments and analyzing the size distribution, relative geometry and shapes of the said uniform color segments and picking features that allow meaningful clustering of images with respect to a pattern descriptor for the said features and a pattern descriptor similarity metric;
quantizing the space of pattern features in P bins by using K-means, K-medoids or a graph clustering algorithm with respect to the pattern descriptor for the features and the said pattern descriptor similarity metric; and
given a dress patch, computing a pattern representation for the patch by computing its pattern descriptor and mapping it to one of the P pattern bins.

13. The computer-implemented method of claim 12 wherein the shapes of the uniform color segments is the discovered pattern feature, the polar distribution of points of the shape is the pattern descriptor and Euclidean distance is the pattern descriptor similarity metric.

14. The computer-implemented method of claim 11 wherein the oriented gradients in the image is the discovered pattern feature, a histogram of the oriented gradients (HOG) is the pattern descriptor and Euclidean distance is the pattern descriptor similarity metric.

15. The computer-implemented method of claim 1, further comprising:
receiving a part D of a dress of type t;
computing color representation g and pattern representation p of D;
computing a neighborhood N of nodes (g,t) and (p,t);
for at least one dress part type t2, computing all nodes (g2,t2) and (p2,t2) in the said neighborhood N that are connected to (g,t) and/or (p,t) by relatively higher weights;
choosing a ranked set of fashion items containing at least one item of dress part of type t2 with color representation g2 and pattern representation p2; and
recommending the said ranked set of fashion items in response to D.

16. A computer-readable medium having stored thereon a plurality of instructions, said plurality of instructions executable by a processor, said plurality of instructions for:
collecting a set of fashion images;
selecting at least one subset within the set of fashion images, the subset comprising at least one image containing a fashion item;
computing a set of segments by segmenting the at least one image into at least one dress segment selected from a group consisting of a dress, a bag, a shoe, a piece of jewelry, a shirt, a suit, a tie, a top, a skirt, and a fashion accessory;
computing color and pattern representations of the set of segments by using a color analysis method and a pattern analysis method respectively; and
creating a graph wherein each graph node corresponds to one of a color representation or a pattern representation computed for the set of segments, and wherein weights of edges between nodes of the graph indicate a degree of how the corresponding colors or patterns complement each other in a fashion sense.

17. A system, comprising:
a processor; and
software instructions executable by the processor, the software instructions for:
collecting a set of fashion images;
selecting at least one subset within the set of fashion images, the subset comprising at least one image containing a fashion item;
computing a set of segments by segmenting the at least one image into at least one dress segment selected from a group consisting of a dress, a bag, a shoe, a piece of jewelry, a shirt, a suit, a tie, a top, a skirt, and a fashion accessory;
computing color and pattern representations of the set of segments by using a color analysis method and a pattern analysis method respectively; and
creating a graph wherein each graph node corresponds to one of a color representation or a pattern representation computed for the set of segments, and wherein weights of edges between nodes of the graph indicate a degree of how the corresponding colors or patterns complement each other in a fashion sense.
